(19) United States
(12) Patent Application Publication
(10) Pub. No.: US 2008/0016054 A1
(43) Pub. Date: Jan. 17, 2008

(54) APPROACH TO MATCHING PROFILES AND ACCESSING CONTACT INFORMATION

(75) Inventor: Jindrich Liska, Arlington, MA (US)

Correspondence Address: SEYFARTH SHAW LLP, WORLD TRADE CENTER EAST, TWO SEAPORT LANE, SUITE 300, BOSTON, MA, 02210-2028, US

(73) Assignee: Vitruva

(21) Appl. No.: 11/771,613

(22) Filed: Jun. 29, 2007

Related U.S. Application Data
(60) Provisional application No. 60/830,040, filed on Jul. 11, 2006.

(51) Int. Cl. G06F 7/08

(52) U.S. Cl. 707/5

(57) ABSTRACT

A system and method for an on-line matching of job seekers with job openings and for score-based access to contact information is disclosed. Both the job seekers and the job openings are identified by their profiles and each profile has multiple parameters. The profile parameters are divided into two distinct categories, fundamental capabilities to perform a job and personal preferences regarding a job, to ensure that both the objective and subjective pictures of the job market are preserved. Correspondingly, two matching scores are calculated sequentially and the results presented simultaneously to job seekers and employers. A user's contact information is released only if the matching score meets the user's specified limit. The two score approach as well as the method for score-based access to contact information can work either together or separately in a variety of profile matching models.

### CROSS REFERENCE TO RELATED APPLICATIONS

The present invention claims priority to U.S. Provisional Patent Application Ser. No. 60/830,040, filed on Jul. 11, 2006, which is incorporated herein by reference in its entirety.

### FIELD OF INVENTION

The present invention relates to the field of matching profiles, and more specifically, matching job seeker profiles with job description profiles, and to manage access to personal contact information.

### BACKGROUND OF THE INVENTION

The Internet based job search has become one of the fastest growing on-line businesses. In 2005, the annual revenue growth of on-line job sites was 20% to 30% and the total revenue of all job sites was around $1.75 billion. The conventional Internet based job search models can be divided into two groups. The first group is represented by the so called “job boards” which allow employers to post job openings and job seekers to submit their resumes. This group is exemplified by companies such as Monster.com, CareerBuilder.com, Indeed.com, or SimplyHired.com. The search technology is focused on matching key words, such as “sales” and “director” as well as various job related categories such as industry, salary, location, and job title. Consequently, the end results of this type of search is a broad match between key words and categories not a quantitative match between resumes and job positions. Therefore, a typical search yields hundreds of job postings/resumes with no quantitative measure (such as a match score) for the end user to gauge how closely a resume matches a particular job.

The second group attempts to overcome the limitations of the first group and uses more accurate technologies to match resumes with appropriate job descriptions. This group is exemplified by companies such as Market10. Similar systems were also described in several patents. When using this technology, job seekers and employers are first asked to fill out extensive profiles which become representations of their resumes and jobs, respectively. Second, the resume profiles and job description profiles are compared with each other in a plurality of profile categories such as Experience, Travel, Skills, Work Authorization, and Salary. The match between a resume and a job description is represented by a single match score (or “One Score”). The value of the “One Score” is typically on a scale 0-100% or 0-10. The higher the score the better the fit is between a resume and a job description. In some “One Score” models, job seekers can see a general view of (e.g. view score range instead of an actual value) how they scored in the individual profile categories. For example, the total “One Score” might be 85% while category scores for Travel and Skills might be in a range 0-50% and 50-100%, respectively. Although “One Score” models provide a good overall idea how well a job seeker's profile matches job description profile, they do not provide immediate information on what type of profile variable to change to increase the score. Specifically, job seekers are left with the following dilemma:
1. Do I increase my “One Score” by making changes in my personal preferences, such as willingness to travel?
(Willingness to travel is a matter of personal preference and the change can be made instantly in a profile if a job seeker so decides.)
2. Or, do I increase my “One Score” by making changes in one of my fundamental capabilities to perform a job, such as industry experience.
(Industry experience is fundamental capability and would require significant career change decision and definitely additional effort and time.)

In “One Score” models, one must run several scenarios to determine which variable change would increase the score, that of personal preference or that of fundamental capability.

Each scenario consists of changing one's profile, one variable change at a time and observing the corresponding impact on the “One Score”—a very time consuming and inefficient process.

Furthermore, since the “One Score” models lump together both types of variables, personal preferences and fundamental capabilities, their results often obscure the true picture of the job market. In the “One Score” models, it is possible for a job seeker with fewer job related skills to achieve a higher score than a job seeker with more job related skills but who has restrictive, but potentially easy to change, personal preferences (e.g. amount of job related travel). Therefore, the “One Score” models are prone to situations where a less qualified job seeker would have a higher matching score and thus a higher probability to get a job.

Another limitation of the existing job matching models is the inflexibility to control of one's contact information. In current job search models employers can access a job seeker's contact information in two ways: “Public” or “Private”. Generally, “Public” access means that the contact information is included with a job seeker's profile and is publicly available to any employer who shows interest in the job seeker. While this option permits contacting a job seeker directly and immediately, it dramatically compromises the privacy and confidentiality of the job seeker. This is even more important on internet job search sites where the contact information can be exposed to millions of people. Furthermore, especially when a job seeker's skills are in high demand, one may end up inundated with a high number of unqualified and unsolicited requests to consider a new job position. Some job search models do allow job seekers to block specific companies from accessing their otherwise publicly accessible contact information. While this helps to protect the privacy of a job seeker from, for example, his or her current employer, the risk of being exposed to unqualified calls and requests from all other companies remains.

To eliminate the risks of making contact information public, current job search models offer a “Private” option that allows job seekers to remain anonymous. In this case, a job seeker can choose to be contacted by a potential employer indirectly, for example via an anonymous email, thus protecting one's privacy and confidentiality. Then, in order to establish direct communication with a potential employer, the job seeker must receive and respond to the anonymous email revealing his/her contact information. The downfall of this option however is that a job seeker would need to perform additional steps in order to establish direct communication with an employer slowing down the entire recruiting process—a clear disadvantage of this option. The time lost with this option may cause a job seeker to miss a potential “dream job” while the employer may end up hiring a job seeker who might not have been the best fit but who was able to be contacted more quickly. In the worst case, the job position may go unfilled.

Furthermore, the “Private∞ option is typically selected by “passive candidates” or “hidden talent” who are often the best talent in the field. They are successful and happy with their current employer and not actively searching for a job, however, they might consider a new job if the right opportunity arose. Unfortunately, due to the limitations of the “Private” option, the best talent represented by “passive candidates” is difficult to reach and therefore rarely recruited through the current internet job search models.

Therefore, there is a need for a more efficient way to access a job seeker's contact information. The new access option described in this invention is based on the matching score between job seeker's profile and a job description profile (“Score” option). The contact information protected by the “Score” option is by default private but becomes temporarily public only to employers whose job profile matching score with a job seeker's profile is very high. The “Score” option would release a job seeker's information only when the matching score exceeds a limit specified by the job seeker.

### SUMMARY

Given the limitations of prior approaches and the current high demand for fast and accurate job matching, best talent=best job, it would be highly desirable to provide job seekers and employers with a much more efficient approach that eliminates limitations of “One Score” models—in particular, an approach which calculates and presents two separate match scores simultaneously (“Two Score” model). In the “Two Score” model, one score represents one's fundamental capability to perform a job (“Fundamental Score”) and the other score represents one's fundamental capabilities and personal preferences (“Total Score”). Therefore, the fundamental capability of a person to perform a job is always measured separately and thus not obscured by personal preferences.

In addition, there is a need for a definition of a finite set of fundamental categories which objectively describe the job seeker's fundamental capabilities to perform a job regardless of his/her personal preferences.

As well, there is yet a further need for providing a breakdown of the “Fundamental Score” into individual fundamental category scores to give job seekers additional insight into the capabilities they may lack or, better yet, excel in for a particular job.

The “Two Score” model significantly improves the job matching accuracy by maintaining two separate matching scores. Both job seekers and employers can instantly see whether the quality of the match is due to their personal preferences or due to their fundamental capabilities to perform a job. At the same time, using the “Fundamental Score”, the “Two Score” model informs job seekers/employers about all employment/talent possibilities in the market at all times which they are not able to see with the current models without incurring additional effort. Moreover, it guarantees that a job seeker never misses a job opportunity which perfectly fits his/her capabilities regardless of the personal preferences specified in his/her profile. Similarly, employers never overlook the best talent despite the salary, travel, and other preferences they specified in the job description profile.

In addition, by providing partial scores, structured according to the fundamental capability categories, job seekers are guided as to what training or experience one may consider to acquire in order to have a better chance to land a specific job. Likewise, it directs employers to the categories which need to be changed in order to attract a larger number or a different caliber of job seekers.

Furthermore, no additional effort is required from job seekers in order to simultaneously see all jobs in the market of which they are capable. This “Two Score” model is particularly attractive for “passive candidates”, who do not want to spend time tweaking their profiles but, at the same time, do not want to miss the right opportunity.

The “Score” option creates, in one embodiment of the present invention, desirable efficiency for job seekers and employers by accelerating communication when a job seeker is highly qualified for a job. It saves employers who are unable to directly contact the well qualified job seeker from hours to days of waiting. At the same time, the “Score” option protects a job seeker from annoying unqualified calls from employers and recruiters. Furthermore, it makes the on-line job search models more attractive to a larger number of job seekers, such as “hidden talent” and higher level professionals and executives, who traditionally have not used the job search models but have relied on other means of job finding. The “Score” based access to contact information ensures that the best talent can be quickly reached by employers who have the best matching jobs.

### BRIEF DESCRIPTION OF THE DRAWINGS

The foregoing and other features and advantages of the present invention will be more fully understood from the following detailed description of illustrative embodiments, taken in conjunction with the accompanying drawing in which:

FIG. 1 is a block diagram depicting an approach to matching profiles according to an embodiment of the present invention;

FIG. 2 is a flow diagram depicting an approach for generating “Two Score” job matching results;

FIG. 3 is a block diagram defining “Fundamental Categories” and “Fundamental Sub-categories”;

FIG. 4 is a flow diagram depicting a routine for specifying privacy settings including “Score” option; and

FIG. 5 is a flow diagram depicting a routine for releasing contact information based on “Score” option.

### DETAILED DESCRIPTION

The invention provides simultaneously two separate matching score results (“Two Score”) to job seekers and employers. Therefore, job seekers and employers are not limited by “one score” matching models which obscure the true picture of the job market, and hide employment opportunities that do not meet personal preferences. In the “Two Score” model, the first score quantifies a match across all profile categories (“Total Score”) which includes both personal preferences and fundamental capabilities to perform job. The second score quantifies a match across only the fundamental capability categories (“Fundamental Score”). The “Fundamental Score” is defined by seven distinct categories and at least one value for each category must be specified before a matching calculation takes place. The “Total Score” includes the “Fundamental Score” and an unlimited number of personal preferences. The personal preferences may or may not be specified for the matching calculation to take place. The “Total Score” is always less than or equal to the “Fundamental Score”.

In addition, the invention provides a method of access to a job seeker's contact information based on the value of the matching score (“Score” option). Therefore, job seekers and employers are not limited by the rigidity of current methods on job search Web sites, where contact information is either public or private. The “Score” option keeps a job seeker's information private by default and makes it public to employers only when the matching score exceeds the limit specified by the job seeker. While the “Score” option herein is described in connection with a job seeker's contact information, it should be clear that the “Score” option can be used to protect any other type of information of any other user of the score based models.

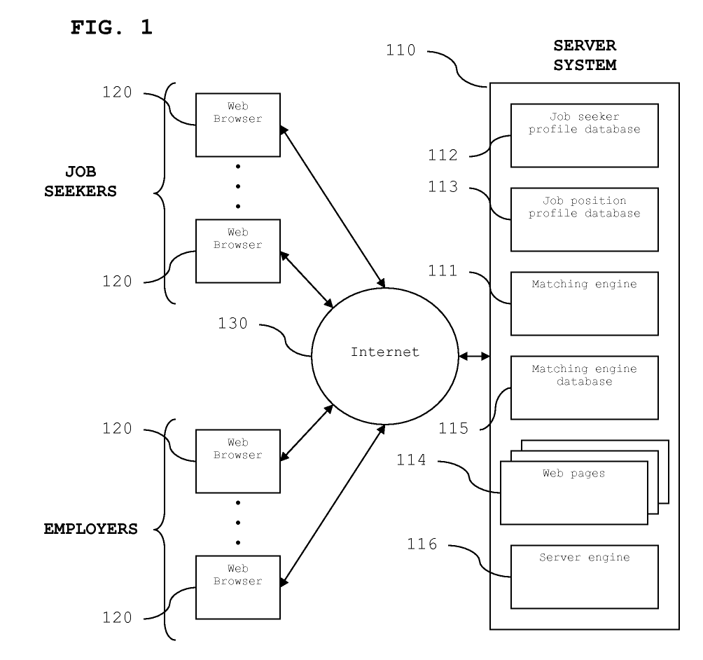

FIG. 1 is a block diagram that illustrates an approach for matching job seeker profiles (provided by job seekers) and job description profiles (provided by employers) according to various embodiments described herein. As used herein, the term “job seeker” refers to any person or entity that possesses capabilities to perform a certain job. Examples of job seekers include employed or unemployed individuals, independent contractor, freelancers, temporary worker and the like and the invention is not limited to any particular type of job seeker. As used herein, the term “employer” refers to any person or entity that is searching for a job seeker who can perform a job described in the job description. Examples of employers include, employers, hiring entities, contracting entities and the like and invention is not limited to any particular type of employer. Either “job seeker” or “employer” may also refer to a third party intermediary who acts in the interest of “job seeker” or “employer”. Examples of the intermediaries include recruiting agencies, employment agencies, “headhunters”, staffing agencies, temporary employment agencies, personal agents, personal managers, and the likes and the invention is not limited to any particular type of an intermediary.

Although the approach to profile matching described herein is in connection with job seeker profiles and job description profiles for illustration purpose only, it should be amply clear that the invention is not limited to this specific job search domain and that the invention can be applied to and adapted to various other domains where pairs of entities (e.g. job seekers and employers) need to be matched. Examples of the other domains include real-estate (e.g. buyers and home sellers), dating (e.g. relationship between two parties), legal (e.g. lawyers and cases), placement (e.g. candidates with residency positions), financial (e.g. financial advisors and client), and the likes.

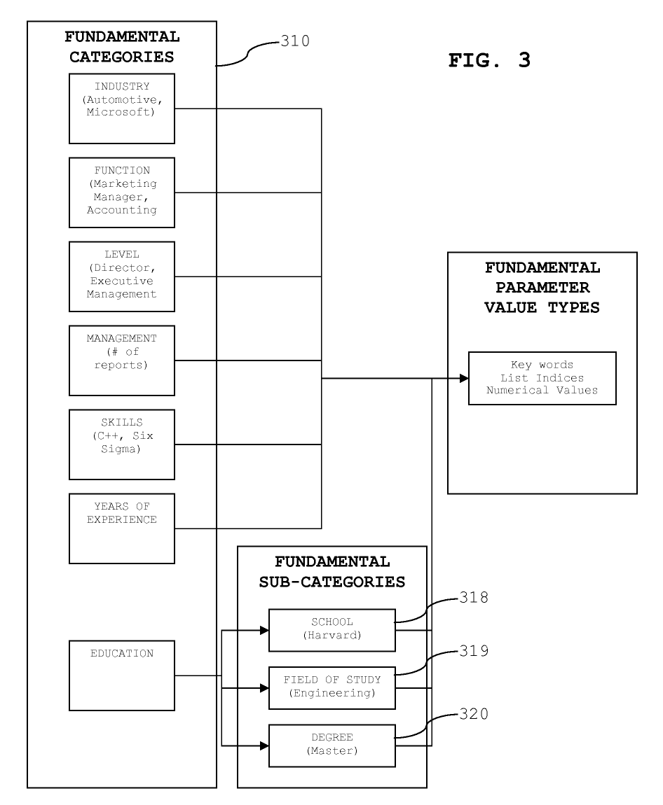

This embodiment supports the “Two Score” matching model and “Score” option to access a contact information over the Internet. The server system 110 includes a matching engine 111, a job seeker profile database 112, a job position profile database 113, various Web pages 114, a server engine 116, and a matching engine database 115. The job seeker profile database contains information about various job seekers. The job seeker information includes contact information, fundamental capability information, personal preference information, favorite profile information, and supporting information. The contact information herein is any information that facilitates communication between the job seekers and employers via electronic message transmission, e-mail, electronic form submission, a telephone call, phone messaging, facsimile messaging, pager and/or beeper messaging, physical mailing address, fax number, instant messaging, and other appropriate communication methods. The fundamental capability information contains any information related to the seven categories as defined in FIG. 3. The personal preference information includes but is not limited to any job seeker preferences, such as compensation level, commuting distance to workplace, amount of job related travel, health benefits, work environment, size of company (in terms of revenue, number of employees), type of company (start-up, private, public), type of position (full-time or part-time), level of security clearance, level of work authorization (citizen or work visa), etc. In this invention, there is no limit on the number of job preferences. The favorite profile information includes information about job description profiles which job seeker decides to store for later use. The supporting information may include information such as job seeker's resume, cover letter, or the like. The job position profile database contains the same type of information as the job seeker database; i.e. contact information, fundamental capability information, personal preference information, favorite profile information, and supporting information. The supporting information, in case of a job position profile, may contain job description, company description, and the like. The matching engine calculates matching scores between job seeker profiles and job description profiles. The matching engine can employ any conventionally available algorithm suitable for comparing two multidimensional profiles. For example, the algorithm can be a simple weighted average, neural network, expert system, or the like. A preferred algorithm is a weighted average. The matching engine database includes information required by the matching engine to calculate the matching scores. This information includes various weights, indices, coefficients, thresholds, constrains or the likes. The server engine receives HTTP requests to access the Web pages identified by URLs and provides the Web pages to the various job seeker and employer systems. The Web pages provide a graphical user interface for job seekers and employers to perform various tasks on the Web site. Those tasks include but are not limited to entering information into the profile databases, requesting the calculation of matching scores, viewing the matching results and corresponding profiles, communicating with other job seekers or employers, and the like.

Job seekers and employers access as well as interact with the Web pages through Web browsers 120 over the Internet 130 as shown in FIG. 1.

One skilled in the art would appreciate that the “Two Score” matching approach can be used in various environments other than the Internet. For example, the “Two Score” matching approach can also be in an e-mail environment in which job seekers and employers can specify profile information and receive corresponding matching results. Also, various communication channels may be used such as LAN, WAN, peer-to-peer communication (such as Skype), and point-to-point dial up connection. Also, the server system may be made up of any combination of hardware or software that can calculate and present matching scores based on job seeker and employer profiles. The job seeker and employer systems can comprise any combination of hardware or software that can interact with a server system. These systems may include personal computers, personal data organizers (PDA), wireless mobile devices (cell phones), television-based systems, internet browsing appliances, or various other consumer products which allow inputting and viewing information.

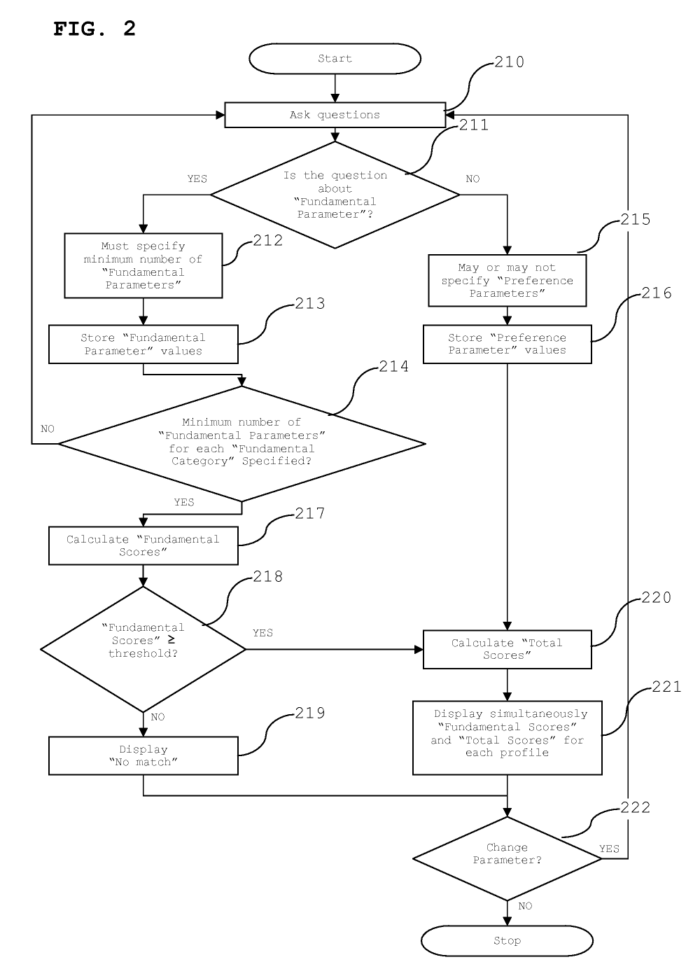

FIG. 2 is a flow diagram depicting an approach for generating “Two Score” job matching results. To calculate the “Two Score” matching results the matching engine needs to have information about both a job seeker and a job description. The process described in FIG. 2 is identical for both the job seeker side and the employer side, therefore only the job seeker side is explained in this section.

The process starts by asking a job seeker a series of questions in step 210. The questions vary in type. For example, some questions can be multiple choice where a job seeker selects one or more choices from a provided list (e.g. select a company from a list of companies.); or the questions can ask for key words (or tags) which relate to a job seeker's capability or preference (e.g. “sales”, “automotive”, “financial advisor”; or the questions can ask for a numeric value (e.g. “10.5” for years of experience). One skilled in the art would appreciate that other types of questions can be used in this process, such as questions asking to rank or order multiple parameters based on specific criteria (e.g. Rank/order the following parameters based on importance to you: compensation, amount of travel, dress code). Each question is related to either fundamental capability parameter (“Fundamental Parameter”) or personal preference parameter (“Preference Parameter”). In the step 211, the server engine determines whether the question is related to a “Fundamental Parameter” that is used in the calculation of the “Fundamental Score” or to a “Preference Parameter” that is used in the calculation of the “Total Score”. If it is “Fundamental Parameter”, the server engine allows a job seeker in step 212 to proceed to the next step only if he or she answers the question, unless a minimum number of “Fundamental Parameters” for a specific “Fundamental Category” has been already specified. In step 213, the answer to the question is stored in the job seeker profile. If the server engine determines in step 211 that the question relates to “Preference Parameter”, a job seeker may or may not answer the question in step 215. In step 216, the answer is stored into the job seeker profile. A blank answer is interpreted later by the matching engine 111 as “no preference”. Then the server engine continues to step 220.

In step 214, the server engine checks if the minimum “Fundamental Parameters” were specified. Only if the minimum “Fundamental Parameters” were specified for each “Fundamental Category” will the process continue to step 217 where the matching engine will calculate “Fundamental Scores” between the job seeker profile and the job position profiles in the database 113. In step 218, the “Fundamental Scores” are compared with a predefined minimum threshold. If none of “Fundamental Scores” is higher than the threshold, then the job seeker is informed that “No match” was found in step 219, else the matching engine continues to step 220 and calculates the “Total Score” for all job description profiles whose “Fundamental Score” is higher than the threshold. In step 221, the server system displays a list of job description profiles, each showing simultaneously two scores: “Fundamental Score” and “Total Score”. Then the server engine continues to step 222. In step 222, if the job seeker decides that he or she wants to change any profile parameter settings then process loops back to step 210, else the process is completed.

FIG. 3 is a block diagram defining “Fundamental Categories” and “Fundamental Sub-Categories”. Both, a job seeker profile and a job description profile, share the same structure of seven “Fundamental Categories” 310 and three “Fundamental Sub-Categories”. “Education” is the only category that is comprised of three sub-categories “School” 318, “Field of Study” 319, and “Degree” 320. Each “Fundamental Category” and “Fundamental Sub-Category” can have one or more “Fundamental Parameters”. Each “Fundamental Parameter” can have one or more values that can be of various types. For example, a value can be an index to a list of items (e.g. “2” for the second company on a list of companies), a key word or a tag (e.g. “sales”, “automotive”, “financial advisor”), or a numeric value (e.g. “10.5” for years of experience).

The category INDUSTRY is comprised of parameters that describe knowledge of and experience in particular industry. Typical parameters in this category include but are not limited to industry names (e.g. automotive), company names (e.g. Microsoft), or product name (e.g. cell phone).

The category FUNCTION is comprised of parameters that describe functional responsibilities. Typical parameters in this category include but are not limited to department name (e.g. marketing), functional title (e.g. direct sales manager), or specialization (e.g. Web designer).

The category LEVEL is comprised of parameters that describe financial or other responsibilities related to the level in a company hierarchy. Typical parameters in this category include but are not limited to a number of levels from CEO (e.g. 3), sale quota responsibility (e.g. $10,000,000), or facility responsibility (e.g. 10 retail stores).

The category MANAGEMENT is comprised of parameters that describe management experience. Typical parameters in this category include but are not limited to number of direct reports (e.g. 5), number of functional reports (e.g. 10), or total number of people under ones management (e.g. 100).

The category SKILLS is comprised of parameters that describe knowledge and experience of various methods, techniques, tools, processes, technologies, foreign languages, etc. Typical parameters in this category include but are not limited to software tools (e.g. SAP), business processes (e.g. auditing), or methods (e.g. Six Sigma).

The sub-category EDUCATION/SCHOOL is comprised of parameters that describe educational institution. Typical parameters in this category include but are not limited to university name (e.g. Harvard), training institute (e.g. Sandler sales institute), or university category (e.g. “Ivy League”).

The sub-category EDUCATION/FIELD OF STUDY is comprised of parameters that describe field of study or training. Typical parameters in this category include but are not limited to study major (e.g. chemistry), special training (e.g. negotiation), or course work (e.g. number theory).

The sub-category EDUCATION/DEGREE is comprised of parameters that describe professional degree or certification. Typical parameters in this category include but are not limited to university degrees (e.g. Master), professional certifications (e.g. Certified Public Accountant), or program certifications (e.g. Microsoft Certified Professional).

The category YEARS OF EXPERIENCE is comprised of parameters that specify years of various types of experiences. Typical parameters in this category include but are not limited to years of functional experience (e.g. years of marketing experience), years of industry experience (e.g. years of automotive experience), or total years of experience.

The “Fundamental Score” is calculated only when at least one “Fundamental Parameter” is specified for categories Industry, Function, Level, Management, Skills, and Years of Experience and at least one “Fundamental Parameter” is specified for the “Fundamental Sub-Categories” School, Field of Study, and Degree. Therefore, at minimum, nine values must be specified before the “Fundamental Score” is calculated. An example of the nine values which satisfy the minimum requirement is provided in table below:

| | | “Fundamental | | “Fundamental |
|---|---|---|---|---|
| | “Fundamental | Parameter” | | Parameter” |
| Number | Category/Sub-Category” | Description | Value Type | Value |
| 1 | INDUSTRY | Industry Name | Index to a list of | 5 |
| | | | industries | |
| 2 | FUNCTION | Functional Title | Key Word | “Marketing |
| | | | | Manager” |
| 3 | LEVEL | Level of | Numerical Value | 10,000,000 |
| | | Responsibilities | | |
| 4 | MANAGEMENT | # of people within | Numerical Value | 100 |
| | | a span of control | | |
| 5 | SKILLS | Tools and | Key Word | “Microsoft |
| | | Methods | | Office” |
| 6 | EDUCATION/SCHOOL | School Attended | Index to a list of | 23 |
| | | | schools | |
| 7 | EDUCATION/FIELD OF | Major Type | Index to a list of | 14 |
| | STUDY | | majors | |
| 8 | EDUCATION/DEGREE | Degree Type | Key Word | “Master” |
| 9 | YEARS OF EXPERIENCE | Years of | Numerical Value | 4.5 |
| | | experience in | | |
| | | FUNCTION | | |

The “Two Score” results are presented in the following ways:
On an employer screen:

| | | | | Fundamental |
|---|---|---|---|---|
| Latest Title | Location | Latest Employer | Total Score | Score |
| Product | MA | ABC company | 67% | 82% |
| Manager | | | | |

On a job seeker screen:

| | | | | Fundamental |
|---|---|---|---|---|
| Job Title | Location | Company Name | Total Score | Score |
| VP of Sales | MA | XYZ company | 77% | 85% |

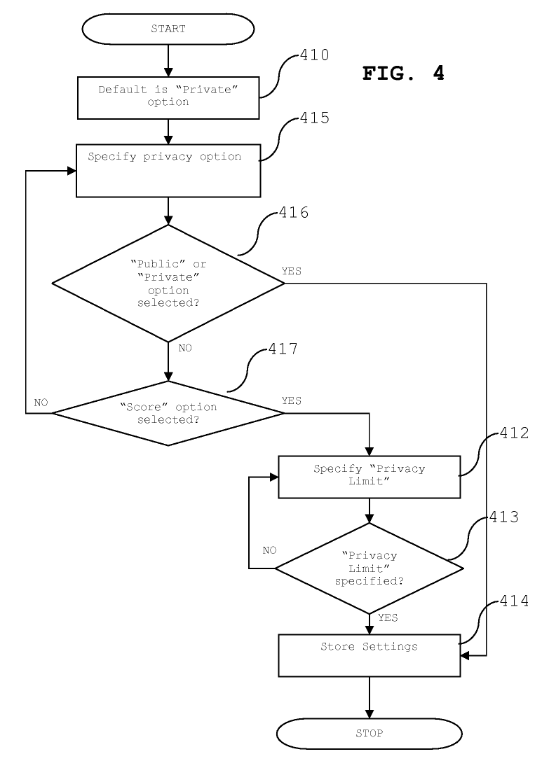

FIG. 4 is a flow diagram depicting a routine for specifying privacy settings with the “Score” option. A job seeker is provided with three options which determine his privacy settings. “Public” option that makes one's contact information public, “Private” option that keeps one's contact information confidential, and “Score” option that releases one's contact information only when a matching score value is higher than or equal to the “Privacy Limit” specified by a job seeker.

The privacy option settings Web page is initially set the “Private” option by default in step 410. A job seeker can modify this setting and can choose from the three options. If either the “Public” or “Private” option is specified in step 415, the privacy settings are stored in step 414 and the process is completed. Else, a job seeker can specify “Score” option in 415. If no privacy option is specified, the routine loops back to default the “Private” option setting. If the “Score” option is selected, in step 412 the job seeker is required to specify the “Privacy Limit” which, when exceeded by a matching score, will trigger the release of the contact information. Step 413 loops back to step 412 until the job seeker specifies the limit. Once the “Privacy Limit” is specified the privacy settings are stored in step 414 and the process is completed.

The matching score which is compared with the specified “Privacy Limit” can be either the “Fundamental Score” or the “Total Score” or any other score representing a match between a pair of profiles. One skilled in the art would appreciate that the “Score” option can be defined by any Boolean combination of two or more scores. An example of the two score combination can be illustrated as follows:

“Release the contact information if “Total Score”>70% AND “Fundamental Score”>90%.

In similar fashion, the “Score” option can be used in combination with any other general privacy options such as a company block (blocking certain companies to access the contact information), a date of the job description profile posting, and the like.

The “Score” option may also be used to trigger release of other information in a profile (e.g. salary level) in addition to personal contact information.

The “Score” option is presented to an end user in the following way:

Specify your Privacy and Confidentiality option:

| Option | Select Only One Option | Conditional Expression |
|---|---|---|
| Private | | |
| Public | | |
| Score | Yes | Minimum Score: 95% |

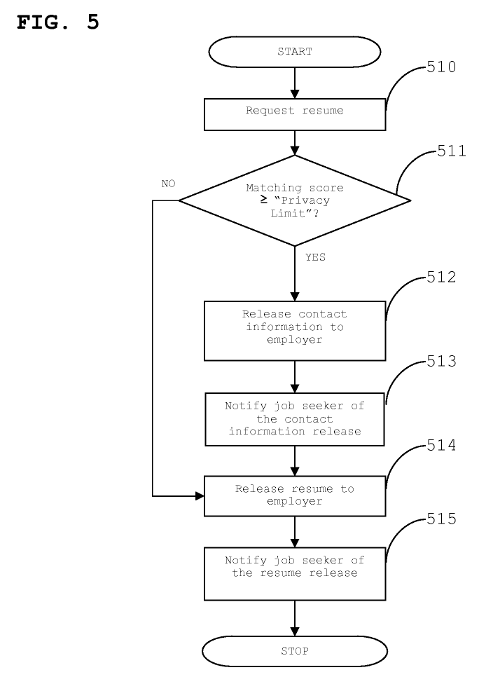

FIG. 5 is a flow diagram depicting a routine for releasing personal information based on the “Score” option. This routine assumes that a job seeker has selected the “Score” option and specified “Privacy Limit” in the privacy settings. In step 510, the routine is initiated by an employer's request for a job seeker's resume. In step 511, if the matching score is higher than or equal to the “Privacy Limit”, a job seeker's contact information is released to an employer in step 512 and a job seeker is notified that his or her contact information has been released in step 513. One skilled in the art would appreciate that the conditional statement in step 511 can be any Boolean expression including a combination of two or more scores and/or other general privacy options as described in FIG. 4. The notification is accomplished by any communication method that uses a job seeker's contact information or combination thereof. Whether or not the “Privacy Limit” was met, the resume is released to an employer in step 514 and a jobs seeker is notified that a resume has been released in step 515. The notification is accomplished by any communication method that uses a job seeker's contact information or combination thereof

Although the illustrative embodiments described above present the two scores simultaneously, one skilled in the are should recognize that the scores may be presented in a variety of ways, such as presenting one score first and the other score in somewhat delayed fashion, e.g. at a push of a button, as a sorting order, on a separate screen, in a separate area of a screen, in a separate email, etc., without deviating from the scope of the invention.

While the illustrative embodiments presented above describe certain groupings or combinations, one skilled in the art should recognize that the seven groups may be grouped or combined into any number of groups or combinations thereof, e.g. the LEVEL category may be combined with MANAGEMENT category into a new category MANAGEMENT LEVEL, without deviating from the scope of the invention.

Further, while the illustrative embodiments detail a “Two Score” system in which the users are presented with two evaluative scores, one skilled in the art should recognize that additional scores may be presented, e.g. a “Three Score” option, etc., to the user without deviating from the scope of the invention.

Further, while the illustrative embodiments describe a correspondence to a variety of parameters, one skilled in the art should recognize any correspondence or weighting can be given to the parameters, or any combination thereof, e.g. adding “Personal Parameters” to “Fundamental Parameters” and allowing weights associated with “Personal Parameters” to be set to zero such that in the end the “Fundamental Parameters” are the greatest significance in the calculation, without deviating from the scope of the invention.

Although the present embodiments above describe calculating a “Fundamental Score” if a minimum number of “Fundamental Parameters” are specified, one skilled in the art should recognize that any number of Fundamental Parameters or combination thereof, may be used to calculate a “Fundamental Score”, without deviating from the scope of the invention.

Although the present embodiments describe a method and system in which a “Total Score” is less than or equal to a “Fundamental Score”, one skilled in the art should recognize that the “Personal Preferences” may be permitted to increase the “Total Score” so that “Total Score” is greater than “Fundamental Score”, without deviating from the scope of the invention.

Although the present embodiments describe combining the “Score” option with the job seeker's contact information, one skilled in the art should recognize that the “Score” option may be combined with any other information without deviating from the scope of the invention.

Although embodiments of the present invention are described in terms of a job seeker resume it should be understood that, in various embodiments, the resume comprises a job application, profile or other compilation of information within the scope of the invention. Similarly, in various embodiments of the invention a job description may comprise a profile, listing, specification or other compilation of information within the scope of the present invention.

Although the scores and results detailed above in the illustrative embodiments are presented in a numerical format, one skilled in the art should recognize that the results may be presented in a number of ways, e.g. color code, sorting order, bar chart, line graphs, pie charts, image, etc., without deviating from the scope of the invention.

What is claimed is:

1. A method of matching job seekers with employment positions, the method comprising:
describing an employment position of an employer in terms of a set of parameters to generate a job description;
describing a job seeker in terms of the set of parameters to generate a job seeker resume; and
comparing the job description to the job seeker resume to generate at least two scores representing correspondence between the job seeker and the employment position.

2. The method of claim 1 wherein the set of parameters includes personal preference parameters and fundamental capability parameters.

3. The method of claim 2 wherein the personal preference parameters are members of the group consisting of: location, travel requirements, work hour requirements, salary requirements and benefits.

4. The method of claim 2 wherein the fundamental capability parameters are members of the group consisting of: industry, function, level, management, skills, years of experience, and education.

5. The method of claim 2 wherein at least one of the at least two scores represents a fundamental score based on a correlation between fundamental capability parameters of the job seeker resume and fundamental capability parameters of the job description.

6. The method of claim 5 wherein the fundamental score includes at least one breakdown score, each breakdown score representing a correlation between a subset of the fundamental capability parameters of the job seeker resume and a corresponding subset of the fundamental capability parameters of the job description.

7. The method of claim 5 further comprising releasing contact information of the job seeker to the employer in response to the fundamental score exceeding a first predetermined threshold.

8. The method of claim 2 wherein at least one of the at least two scores represents a total score based on a correlation between the set of parameters including personal preference parameters and fundamental capability parameters of the job seeker resume and the set of parameters including personal preference parameters and fundamental capability parameters of the job seeker resume.

9. The method of claim 8 further comprising releasing contact information of the job seeker to the employer in response to the total score exceeding a second predetermined threshold.

10. The method of claim 2 wherein at least one of the at least two scores represents a fundamental score based on a correlation between fundamental capability parameters of the job seeker resume and fundamental capability parameters of the job description, and wherein at least one of the at least two scores represents a total score based on a correlation between the set of parameters including personal preference parameters and fundamental capability parameters of the job seeker resume and the set of parameters including personal preference parameters and fundamental capability parameters of the job seeker resume.

11. The method of claim 10 further comprising releasing a contact information of the job seeker to the employer in response to the fundamental score exceeding a first predetermined threshold and the total score exceeding a second predetermined threshold.

12. The method of claim 1 further comprising describing an information release preference of the job seeker as public, private or score based.

13. The method of claim 12 further comprising protecting contact information of the job seeker in response to describing the information release preference of the job seeker as private.

14. The method of claim 12 further comprising releasing contact information of the job seeker to the employer in response to describing the information release preference of the job seeker as public.

15. The method of claim 12 further comprising releasing contact information of the job seeker to the employer in response to at least one of the at least two scores exceeding a predetermined threshold when the information release preference of the job seeker is described as score based.

16. The method of claim 1 further comprising presenting the at least two scores to the employer.

17. The method of claim 1 further comprising presenting the at least two scores to the job seeker.

18. A method of matching job seekers with employment positions, the method comprising:
describing an employment position of an employer in terms of a set of parameters to generate a job description;
describing a job seeker in terms of the set of parameters to generate a job seeker resume;
comparing the job description to the job seeker resume to generate at least one score representing correspondence between the job seeker and the employment position; and
releasing contact information in response to the at least one score exceeding a predetermined threshold.

19. The method of claim 18 wherein the releasing of contact information comprises releasing contact information of the job seeker to the employer.

20. The method of claim 18 wherein the releasing of contact information comprises releasing contact information of the employer to the job seeker.

21. A system for matching a set of profiles comprising:
a first set of parameters;
a second set of parameters; and
a matching engine for correlating the first and second set of parameters, the engine outputting at least two scores, the scores representing a level of correspondence between the profiles.

22. The system of claim 21 wherein the first set of parameters comprise objective parameters and the second set of parameters comprise subjective parameters.

23. The system of claim 21 wherein the set of profiles comprises a job seeker profile and an employer profile.

24. A system for matching job seekers with employment positions, the system comprising:
means for describing an employment position of an employer in terms of a set of parameters to generate a job description;
means for describing a job seeker in terms of the set of parameters to generate a job seeker resume; and
means for comparing the job description to the job seeker resume generate at least two scores representing a level of correspondence between the job seeker and the employment position.
